(19) United States
(12) Patent Application Publication
(10) Pub. No.: US 2008/0111792 A1
(43) Pub. Date: May 15, 2008

(54) INPUT DEVICE INCLUDING WIRELESS AND WIRED MODES

(75) Inventors: Benjamin Roberts, White Rock (CA); John Cavacuiti, North Vancouver (CA); Juan Ernesto Rodriguez, Woodside, CA (US); Steven A. Gelphman, Half Moon Bay, CA (US); Gary Ga Hoi Wong, Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO Brands USA LLC, Lincolnshire, IL (US)

(21) Appl. No.: 11/939,660

(22) Filed: Nov. 14, 2007

Related U.S. Application Data
(60) Provisional application No. 60/866,005, filed on Nov. 15, 2006.

(51) Int. Cl. G06F 3/033; G09G 5/00

(52) U.S. Cl. 345/163; 345/156

(57) ABSTRACT

An input device is disclosed. The input device includes an outer housing, a sensor assembly configured to sense a position of the input device relative to a work surface, a wireless transmitter coupled to the sensor assembly, and a cable comprising a cable connector configured to connect to a data port in a computer on one end of the cable. The cable has both data and power lines, and the input device is capable of operating in both a wired and a wireless mode.

### CROSS-REFERENCES TO RELATED APPLICATIONS

This patent application is a non-provisional of and claims priority to U.S. provisional patent application No. 60/866,005, filed on Nov. 15, 2006, which is herein incorporated by reference in its entirety for all purposes.

### BACKGROUND

A number of computer input devices, such as computer mice, exist today. Such input devices have become crucial to controlling programs and other aspects of computers. Computers have also become smaller and more powerful over the past few decades, and portable computes such as laptops have become ubiquitous. Such computers allow for varied placements in relation to the user. As the dynamics of computer usage has changed, there has arisen a need for more flexibility in the control of the computer.

Computer mice in particular are required to work in any computer usage situation. Often the mouse is the only means of control a user has over a computer. Particularly for a laptop in an unfamiliar environment such as a conference room, the placement of the mouse will need to vary from where it would be in a static, desktop environment.

For the foregoing and other reasons, the popularity of wireless mice has been rising. By removing the need for a cable to connect the input device to the computer, wireless mice reduce clutter and allow for greater flexibility in usage and placement of the device. Wireless mice are particularly well suited for use with laptop computers since they have fewer cables to carry with them.

Although wireless input devices are more convenient, the lack of a cable connecting them to the computer creates a new set of problems. Wired input devices have a cable that sends signals back and forth between the device and the computer, and the cable also provides power to the device. Without the cable, wireless mice must contain their own power source, such as batteries. The batteries can die suddenly, leaving the input device powerless and useless. Such problems can be exacerbated when the input device is used in conjunction with a laptop computer in a remote location, where replacement batteries are hard to locate. Further, constantly replacing disposable batteries can be cost prohibitive.

Rechargeable batteries have also been used as a power source. But rechargeable batteries will often lose their charge over extended periods of time, as well as require specialized charging hardware. This specialized hardware is burdensome to carry with the mouse and can negate the advantages of the device being wireless. There is a need in the art for an input device that combines the convenience of a wireless mouse with the worry free power supply of a wired mouse.

Embodiments of the invention address these and other problems.

### BRIEF SUMMARY

Embodiments of the present invention relate to devices for inputting commands to a computer. The commands are sent to the computer from an input device, which may be a mouse, trackball, or the like.

One embodiment of the present invention is directed to an input device comprising a housing, and within the housing a sensor assembly to sense the position of the device. A wireless transmitter is coupled to the sensor assembly, as is a cable that is configured to connect to a data port of a host. The cable contains both data and power lines. In one implementation, the cable is stored within the input device when not in use. In another aspect of this embodiment, the wireless transmitter communicates with a host through a wireless receiver dongle. The dongle resides in a cavity in a bottom housing of the input device when not in use, and may connect to a PCI Express-type port in a computer when in use.

Another embodiment of the present invention is directed to a dongle assembly that connects to a host. The dongle assembly receives a control signal from an input device. In one implementation, the dongle assembly fits within a PCI Express-type data port of a host. In one implementation, the assembly is configured to connect to a data port in a host, and at the same time can connect to a cable coupled to an input device.

Another embodiment of the present invention is directed to a method of using the above-described device. The method comprises using the device both in a wireless state, and also using it while it is connected to a host through a cable comprising data and power lines.

Another embodiment of the present invention is directed to a method of making an input device. The method comprises building an input apparatus that contains both a wireless transmitter and a cable containing power and data lines.

These and other embodiments of the invention are described in further detail below.

### BRIEF DESCRIPTION OF THE DRAWINGS

FIG. 1 shows a perspective view of the top of a computer input device according to an embodiment of the invention.

FIG. 2 shows a perspective view of the bottom of a computer input device housing a dongle, according to an embodiment of the invention.

FIG. 3 shows a perspective view of the bottom of a computer input device according to an embodiment of the invention.

FIG. 4 shows a perspective view of the bottom of a computer input device showing a recess for holding a dongle, according to an embodiment of the invention.

FIG. 5 shows a dongle according to an embodiment of the invention.

FIG. 6 shows an expanded view of a computer input device according to an embodiment of the invention.

FIG. 7 shows an expanded view of the inside of a computer input device according to an embodiment of the invention.

FIG. 8 shows a perspective view of a dongle assembly and a computer data port according to an embodiment of the invention.

FIGS. 9(a) and 9(b) shows a circuit diagram of some functional components of a computer input apparatus according to an embodiment of the invention.

FIG. 10 shows a block diagram of some functional components of a system according to an embodiment of the invention.

### DETAILED DESCRIPTION

One embodiment of the present invention is drawn towards a mouse for controlling a computer, preferably a personal computer. The mouse contains both a wireless transmitter for communication, and a cable for connecting to the computer. The mouse is designed to be used in a wireless mode and can be powered by batteries. However, in some situations using the mouse in a wired mode, in conjunction with the cable, will be preferable. Such situations include the batteries not having power, or where wireless signals are not allowed, such as on an airline flight.

In preferred embodiments, the cable is permanently affixed to the mouse, and can be stored within the mouse. The end of the cable that connects to the host computer can be pulled out of the mouse when needed, and attached to a port of the computer. The mouse can then draw power through the cable from the computer, and also provide control signals back to the computer through the cable.

In certain embodiments, the mouse will communicate with a computer wirelessly. This can be done using any number of wireless standards, including 27 MHz, 2.4 GHz, Bluetooth, or any other suitable wireless system. The mouse can communicate using such standard with a computer that has a built in receiver. In certain implementations, though, a computer will need to use an external receiver connected to a data port. This external receiver can take the form of a dongle assembly or card that connects into a PCI Express port, or other port, of a computer. The external receiver may also have a separate port for connecting with the cable attached to the mouse during non-wireless operation. In one implementation, the external receiver has a quick-start feature such that there is little lag time between plugging in the receiver and its being available for use. The mouse will very quickly be able to start communicating with the computer in this implementation.

Embodiments of the invention have a number of advantages. The mouse of certain embodiments can be used in both a wired and wireless modes. This allows for both the convenience and flexibility of a wireless mouse, with the reliability and security of a wired mouse. Furthermore, the cable is stored within the mouse in certain embodiments so that transporting the mouse is simplified and there is no chance of losing the cable. The quick-start feature of the wireless receiver allows for less wasted time before being able to use a mouse.

In the specific embodiments that are described below, a “computer input device” is described in detail and a host in the form of a computer is described in detail. Embodiments of the invention are not limited to the specific embodiments described herein, and embodiments of the invention may be used to control devices including computers, MP3 players, televisions, projectors, etc. Also, the “input device” is preferably a computer input device such as a computer mouse.

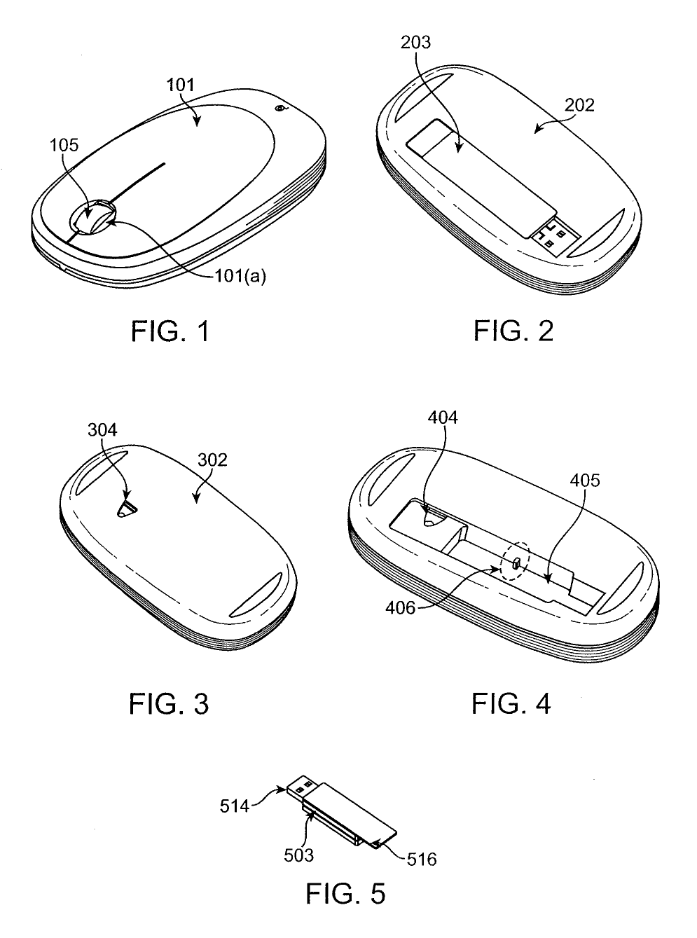

FIGS. 1 through 5 show various views and embodiments of a computer input device according to the invention. FIG. 1 shows a perspective view of the top of a computer input device with a top housing portion 101 according to an embodiment of the invention. FIG. 2 shows the bottom of one embodiment of the input device. The figure shows a bottom housing portion 202 containing a recess that is holding a dongle assembly 203. The dongle 203 is capable of connecting to a data port of a computer and receiving wireless signals from the mouse. A scroll wheel 105 is present within an aperture 101(a) in the top housing portion 101.

FIG. 4 shows the input device of FIG. 2 with the dongle assembly removed. The removed dongle 503 is shown in FIG. 5. The dongle assembly contains a connector 514 for communicating with a host computer, and in certain embodiments a second connector 516 for receiving a cable connector. Connector 514 may be of a PCI-type Express type, and connector 516 may be a universal serial bus (USB) connector. Without the dongle of FIG. 5, recess 405 is visible containing a power switch 406. In certain preferred embodiments, the power switch 406 is depressed when the dongle is inserted in recess 405, resulting in the computer input device powering down. In such embodiments, when the dongle assembly is removed, power switch 406 is released, resulting in the computer input device powering on. In this fashion, the input device conserves power when not in use, as it is automatically turned off when the dongle assembly is stored within recess 405, and automatically turns on when the dongle assembly is removed. Sensor assembly 404 is within recess 405, and will be covered by the dongle of FIG. 5 when it is stored. Sensor assembly 404 is uncovered when the dongle is removed from recess 405, and can sense the position of the input device relative to a work surface.

FIG. 3 shows the bottom view of another embodiment of an input device. This embodiment has a bottom housing 302 that does not contain a recess holding a dongle assembly. Bottom housing 302 holds a sensor assembly 304 for sensing the device position relative to a work surface (not shown). In this embodiment, sensor assembly 304 remains uncovered regardless of the state of the input device. In another embodiment, bottom housing 302 may comprise a slide switch that covers sensor assembly 304 when not in use.

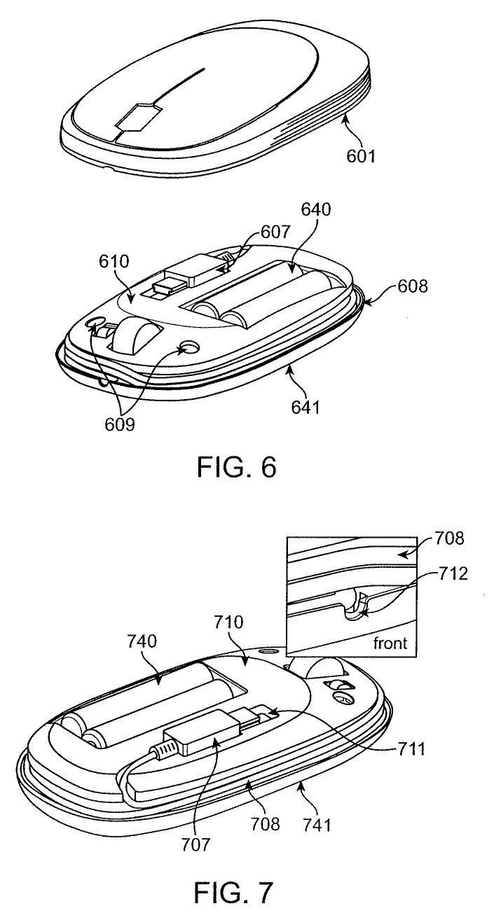

FIG. 6 shows an embodiment of a computer input device according to the present invention, wherein the top housing portion 601 of the computer input device has been separated from the bottom housing portion 641. The top housing portion 601 and bottom housing portion 641 may be held together by magnets 609 within the bottom housing portion 641. The magnets 609 may magnetically couple to corresponding magnets (not shown) in the top housing portion 601, allowing for secure fastening to form an outer housing, and also easy separation. The housing portions 641, 601 are designed to be separable so that the inside of the input device is accessible.

An inner housing 610 is present within the outer housing, which is formed by the top housing portion 601 and the bottom housing portion 641. As shown, the inner housing 610 includes a number of recesses to receive a number of components of the input device. For example, located within an inner housing 610 is the power supply 640. The power supply can be in the form of two or more alkaline or lithium batteries. Also residing in a recess in the inner housing 610 is one end of a cable 608. The end of the cable 608 comprises a connector 607. This connector 607 can connect to a host computer device such as a laptop or desktop computer. In preferred embodiments, the connector 607 is capable of connecting to a USB port of a computer.

In this example, the cable 608 contains both power and data lines (not shown). As such, certain embodiments of the input device provide that it can connect to a computer and provide control signals even when there is no power being provided by power supply 640. To properly conduct both power and data, cable 608 comprises at least 4 conductors. Both the power and the data lines shall each comprise a positive and a negative conductor. Cable 608 is coupled to a sensor assembly (not shown) in the device, and transmits data from the sensor assembly to a host device (not shown).

FIG. 7 shows the computer input device of FIG. 6 from the reverse angle. The cable 708 is wrapped around inner housing 710 for storage, and terminates in connector 707. When the cable 708 is not being used (such as when the mouse is being operated in a wireless state, or is powered off), the cable 708 is stored in the manner shown, and the connector resides in a recess 711 in inner housing 710. More specifically, the cable 708 is manually wound around the inner housing 610.

As noted above, the computer input device may be powered by power supply 740. The cable 708 contains both power and data lines, and can connect through connector 707 to a host computer (not shown). In such instances, the top housing 601 (FIG. 6) is removed from bottom housing 741 in order to access the cable 708. Connector 707 is removed from the recess 711 in inner housing 710, and cable 708 is unwound from around the inner housing. Cable 708 is then placed in the divot 712 created in the bottom housing portion 641 as shown in the inset of FIG. 7, and the top and bottom housing portions 610, 641 are reattached. In this method the mouse can be switched from a wireless to a wired mode.

The computer input device that is described above contains a wireless transmitter in order to communicate with a host computer when operating in a wireless mode. FIG. 5 shows a dongle assembly that receives signals from the wireless transmitter, and connects to a host computer. The dongle assembly of FIG. 5 resides inside a portion of the computer input device when it is not in use.

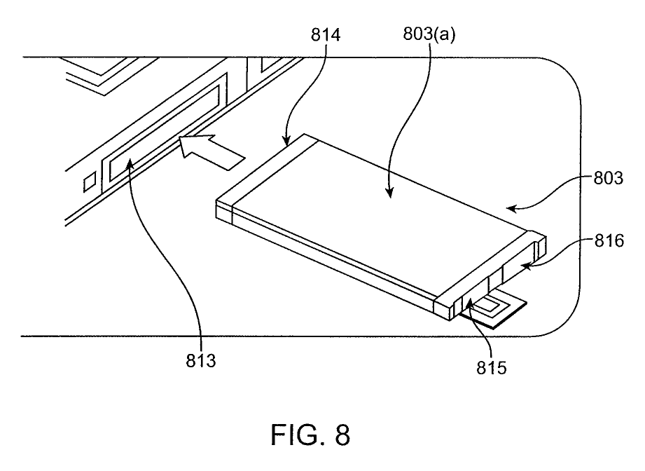

In other embodiments, the dongle assembly may not be attached to or stored in the computer input device. For example, the dongle assembly 803 shown in FIG. 8 does not reside in a computer input device when it is not in use. It is designed to preferably stay within a computer slot 813, or it may be carried separately from the computer input device. In this embodiment, the dongle assembly 803 connects with computer slot 813 through connector 814. Housing 803(a) of dongle 803 is configured to fit within slot 813. Antenna 815 is a wireless receiver that resides within the dongle assembly, and is configured to receive signals such as control signals from a computer input device. In certain preferred embodiments, antenna 815 is configured to be capable of extending outside of assembly 803, in order to extend the signal reception capabilities of the dongle assembly. Dongle assembly 803 may also have connector 816, which is configurable to receive a cable connector such as cable connector 707 in FIG. 7. The connector 816 is a female connector in this example, but could be a male connector in other examples. Connector 814 is preferably of a PCI Express-type of connector, which is for connecting to a PCI Express-type interface in a computer. To fit dongle assembly 803, computer slot 813 is preferably a PCI Express-type slot. Alternatively, connector 814 and computer slot 813 may conform to the standards of a PCI-type, a USB-type, a PCMCIA-type, a SCSI-type, or other suitable interface.

The PCI Express standard provides a scalable, high speed, serial I/O bus that maintains backward compatibility with PCI applications and drivers. A PCI Express architecture has a topology which contains a host bridge and several endpoints (the I/O devices). Compared to the older PCI (peripheral components interface) standard, the PCI Express architecture has multiple point-to-point connections and introduces a new element, the switch, into the I/O system topology. The switch replaces the multi-drop parallel bus PCI technology and is used to provide fan-out for the I/O bus. A switch may provide peer-to-peer communication between different endpoints and this traffic, if it does not involve cache-coherent memory transfers, need not be forwarded to the host bridge. The switch can be a separate logical element, or it could be integrated into a host bridge component. A PCI Express interface or PCI connector may thus be adapted for use with a switching, serial bus architecture.

PCI Express cards have also been developed and are used in conjunction with PCI Express interfaces. Current PCI standard and low-profile cards are used in a variety of platforms, including servers, workstations, and desktops. PCI Express also defines standard and low-profile cards that can replace or coexist with legacy PCI cards. These cards have the same dimensions as PCI cards and are equipped with a rear bracket to accommodate external cable connections. The differences between the PCI and PCI Express cards lie in their I/O connectors. An x1 PCI Express connector has 36 pins, compared to the 120 pins on a standard PCI connector.

PCI Express cards include ExpressCard modules, which currently have two different module widths: 34 mm and 54 mm. ExpressCard modules can be plugged into an external ExpressCard slot in a portable computer or the like, just as PC Cards are used today.

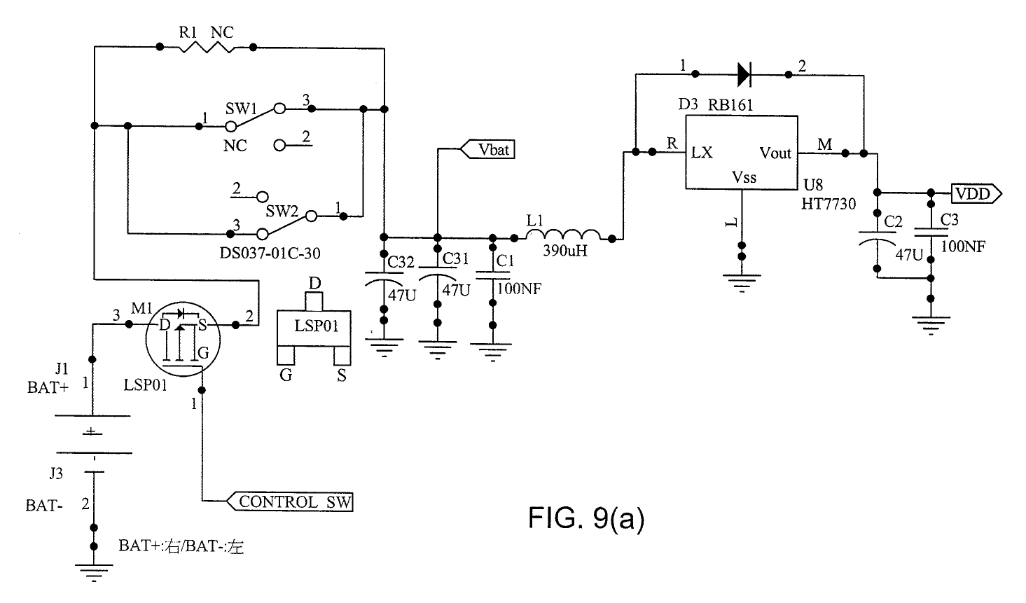

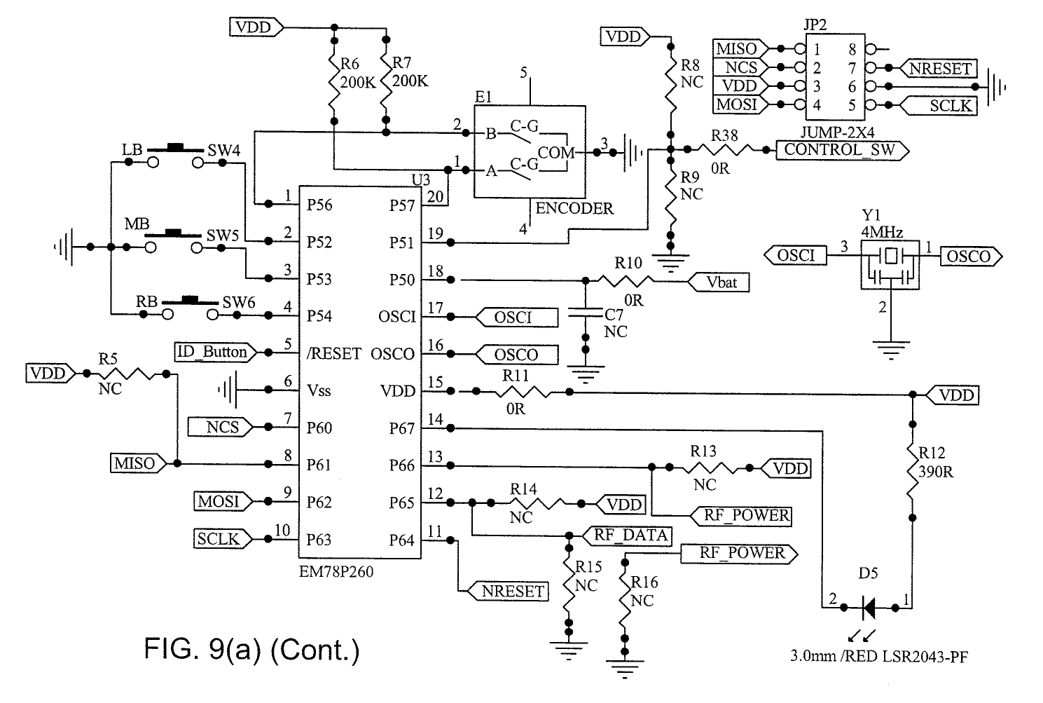

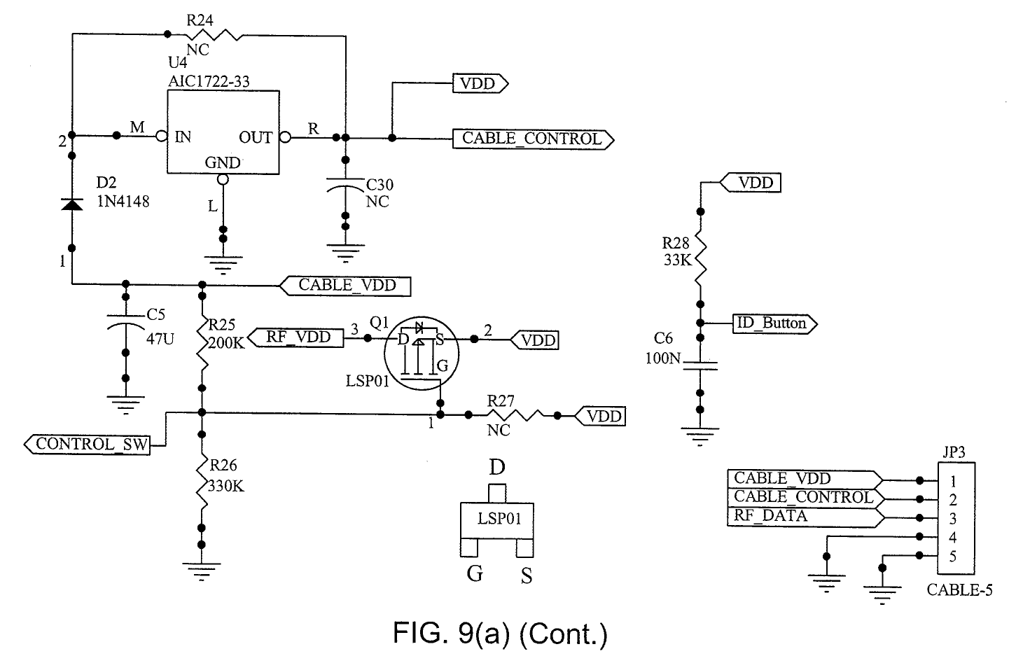

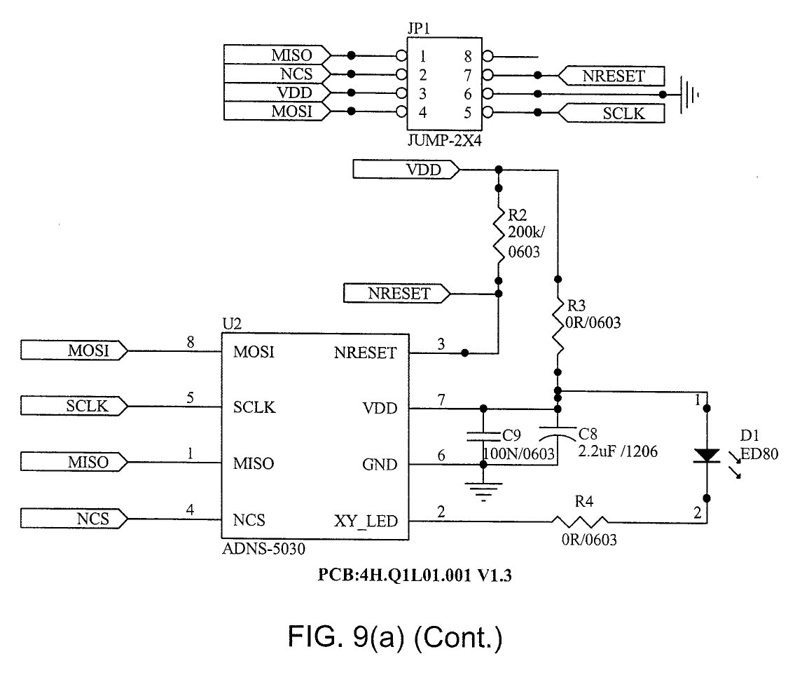

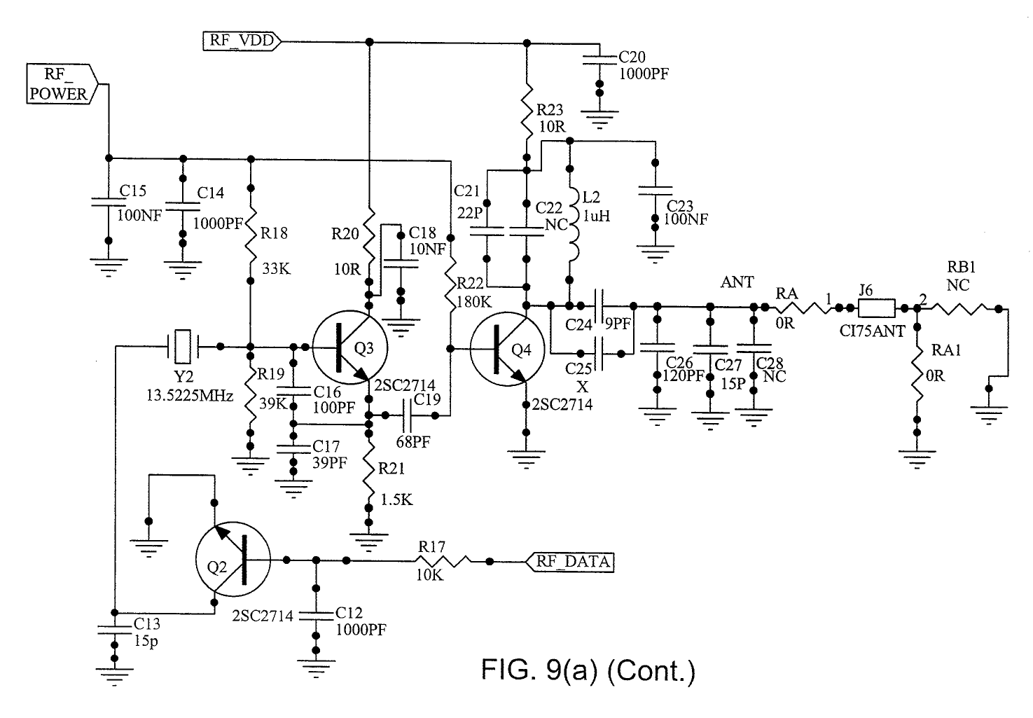

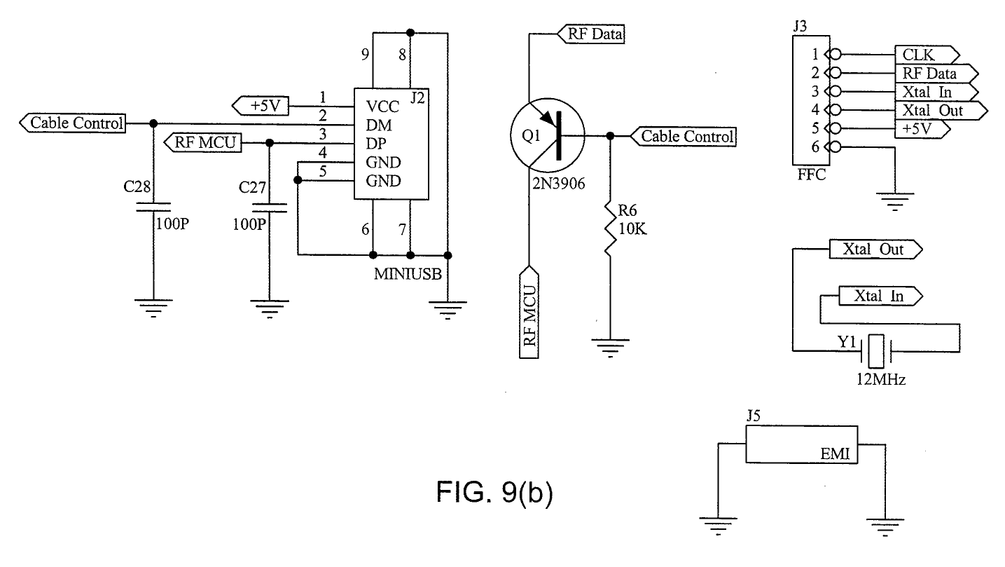

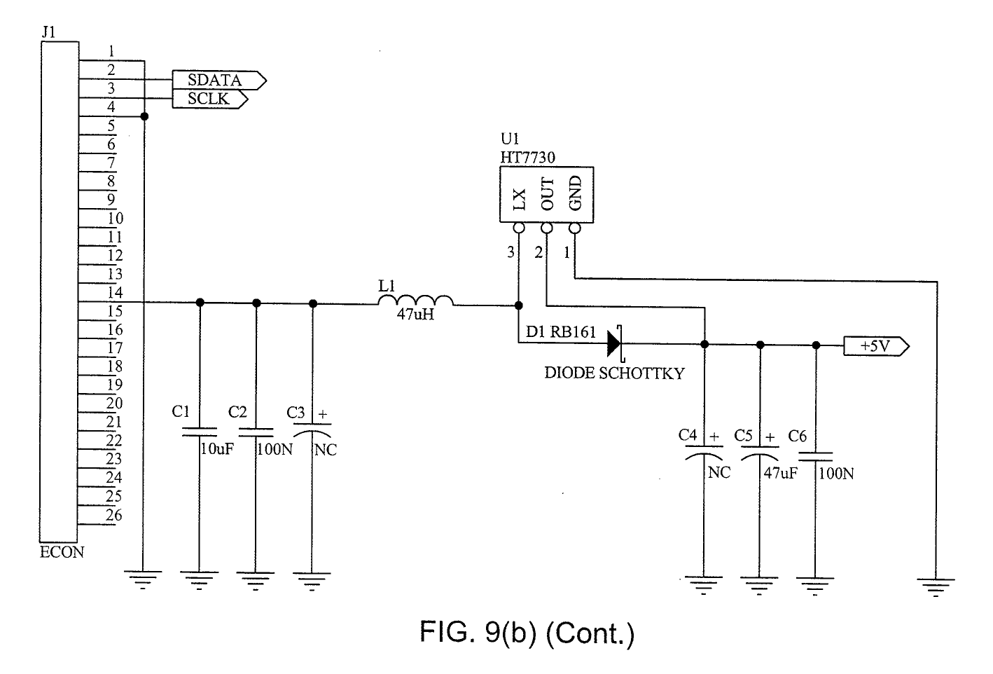

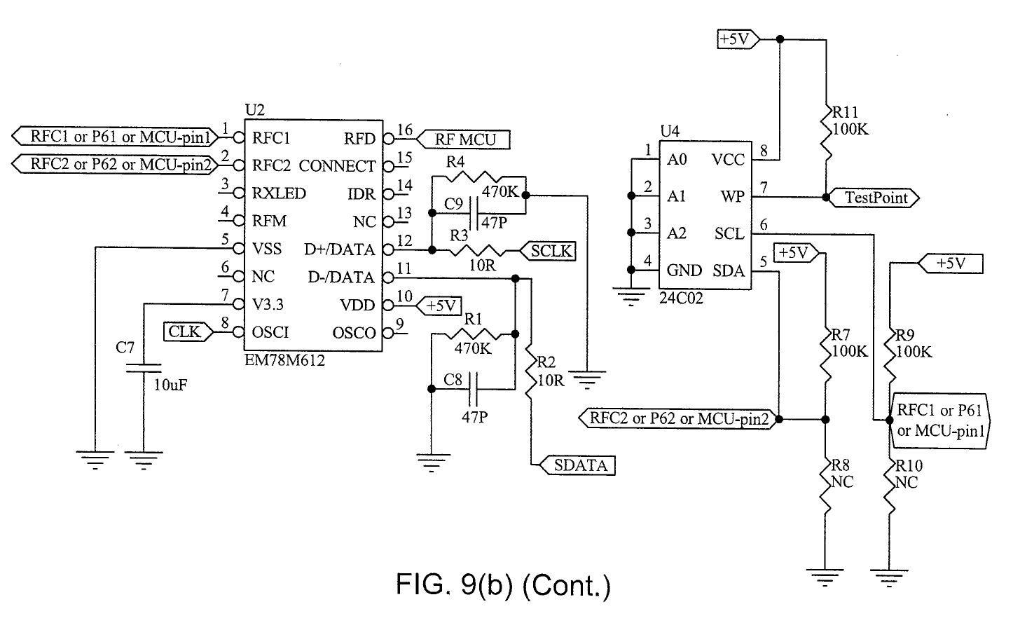

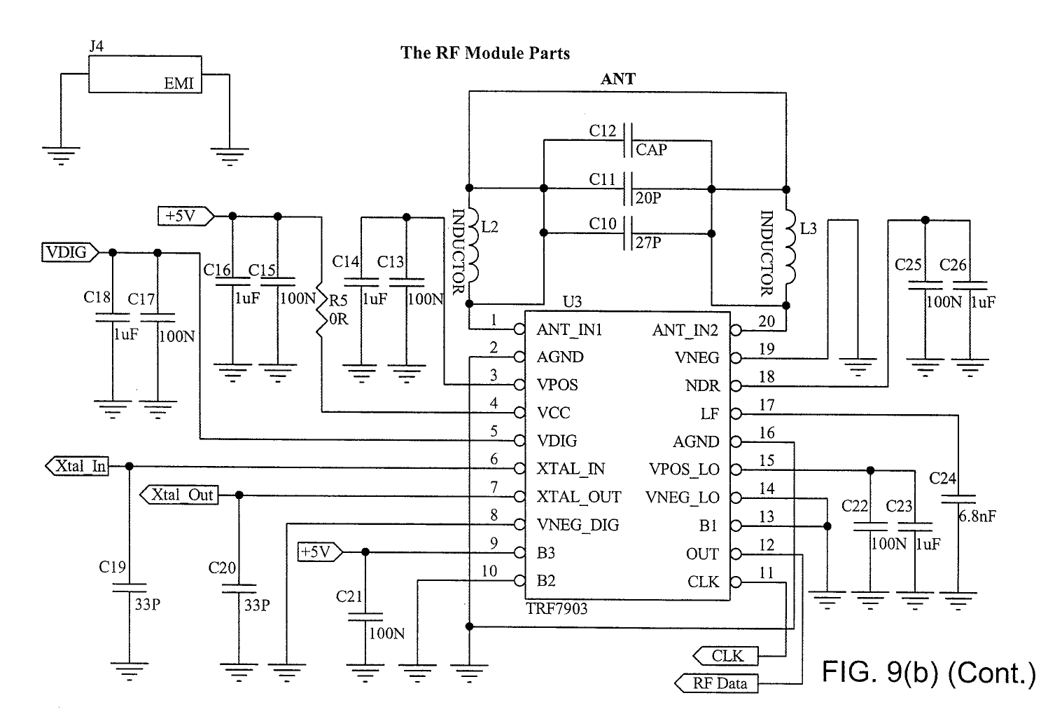

An exemplary circuit diagram of an embodiment of the input device is shown in FIG. 9(a), and an exemplary circuit diagram of an embodiment of a dongle assembly is shown in FIG. 9(b). It is understood that other suitable circuits could alternatively be used in embodiments of the invention, and embodiments of the invention are not limited to the specific implementation shown in FIGS. 9(a) and 9(b).

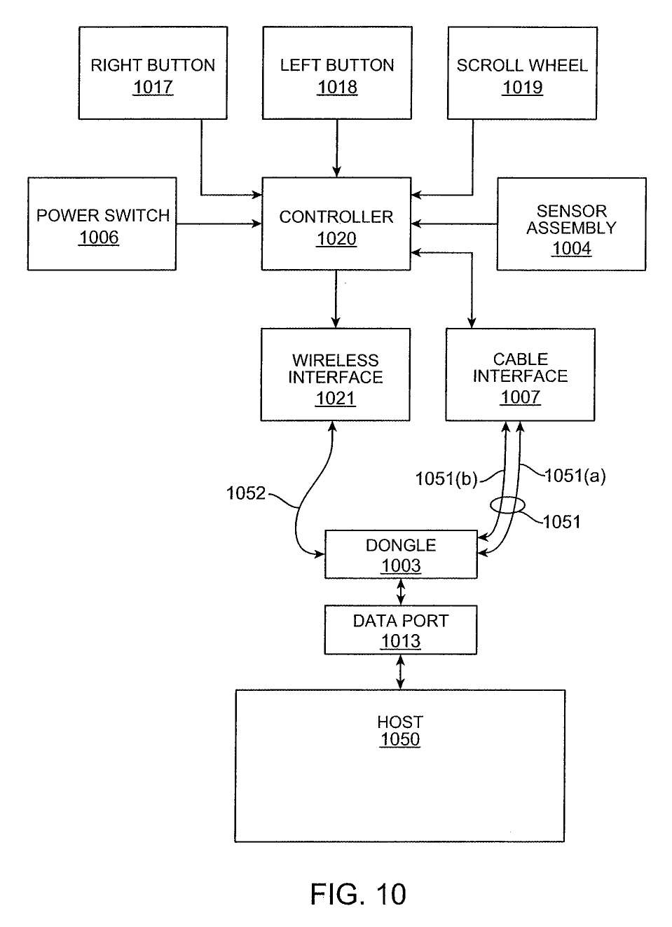

FIG. 10 shows a block diagram of a system according to an embodiment of the invention. The system may include a computer input device 1001 with a left button 1017 and a right button 1018 for control by a user, along with a scroll wheel 1019. Each of the left button 1017, the right button 1018, and the scroll wheel 1019 may be operatively coupled to a controller 1020, and control signals may be sent from them to the controller 1020. The controller 1020 can be a microprocessor and may separately packaged from the sensor assembly 1004 or within the same package as the sensor assembly 1004.

A sensor assembly 1004 is also coupled to the controller 1020. The sensor assembly 1004 is preferably an optical sensor assembly, but it may also be a mechanical or other type of sensor assembly. Sensor assembly 1004 senses the position of the input device relative to a work surface, and sends that information in the form of a signal to controller 1020. In preferred embodiments, the sensor assembly 1004 contains a light source such as an LED or laser. The light source provides light to a work surface and reflected light from the work surface can be received by a camera or the like in the sensor assembly 1004.

A power switch 1006 is also coupled to and instructs the input device controller 1020 as to when the computer input device will power off and when it will power on. The power switch 1006 can be a manual power switch that can be actuated by a user, or can be an automatic power switch that can automatically turn off the computer input device (e.g., when the computer input device has not been used for a predetermined time or when a dongle such as the dongle in FIG. 5 is placed within a recess in the bottom of the device).

As shown in FIG. 10, controller 1020 coordinates the various signals it receives and delivers them to a host 1050. Host 1050 is preferably a personal computer, but may be any electronic device capable of accepting control signals. Host 1050 receives control signals through a data port 1013 that may be connected to a dongle 1003. Data port 1013 is preferably of a PCI Express-type. In FIG. 10, dongle 1003 plugs into data port 1013, and is configured to receive both wireless signals 1052 and have a port for connecting to a cable 1051. Cable 1051 is configured to transmit both power and data between the host 1050 and the input device. As such, cable 1051 comprises a data line 1051(a), and a power line 1051(b). Data line 1051(a) and power line 1051(b) will each comprise two conductors to transmit data and power respectively, such that cable 1051 comprises at least 4 conductors in total. In one embodiment, the system is a one-way communication system such that data is transmitted from the input device to host 1050. In another embodiment, the system is a two-way communication system such that data is transmitted from the input device to host 1050, and also from host 1050 to the input device.

The use of a PCI Express compatible dongle has advantages. For example, PCI Express slots in computers are not used in some cases, since such slots are generally designed for video links and the like. Allowing an input device such as a mouse to communicate with a PCI Express slot frees up USB ports on a computer so that the USB ports can be used for other peripherals. Also, it is not intuitive to use a PCI Express slot to communicate with an input device such as a mouse, since PCI Express slots are designed to handle large amounts of data and the data transmission between a mouse and a computer is typically not large. PCI Express slots are configured to achieve speeds up to 10 Gigabits per second, whereas input devices such as computer mice normally operate at no more than 1.5 Megabits per second.

Controller 1020 communicates with the host in either a wired or a wireless fashion. In a wired fashion, controller routers the communication signals through a cable interface 1007 that is connected to a cable 1051. Cable 1051 transmits the communication (e.g., data) signals to the host 1050 and also transmits power from the host 1050 back to the cable interface 1007. In the wired mode, no wireless signals are needed and the power and data transmission between the computer input device 1001 and the host 1050 can be provided over the cable 1051. In certain embodiments, while in the wired mode, all wireless systems are turned off such that only the wired mode is used.

Communication in a wireless fashion occurs when the controller 1020 routes the communication signal through wireless interface 1021. Wireless interface 1021 emits wireless signals 1052 that are received by dongle 1003. Wireless interface 1021 can conform to any number of wireless standards, including 27 MHz, 2.4 GHz, Bluetooth, or any other suitable standard. In a preferred embodiment, the 27 MHz standard is used. The dongle 1003 receives the wireless signals from wireless interface 1021, and sends the desired signal to the host 1050 through data port 1013. In the wireless mode, the input device may be powered by a power source contained within the input device, or by power provided through cable 1051.

Methods for using the computer input device are also disclosed. In one embodiment, a method of use includes removing a wireless dongle assembly from the bottom of a computer input device, connecting the dongle assembly to a data port in a computer, and using the computer input device. Then, there may arise a need for the input device to be used in a wired mode. The dongle may be removed from the computer and placed back within the cavity of the input device. A cable attached to the input device is plugged into a computer, either via the dongle (if left connected to the computer) or by being plugged directly to a port of the computer, and the input device is further used. The cable may transmit both power and data during usage in the wired mode. After using the computer input device, the cable may be unplugged from the computer and wrapped around an inner housing of the device for storage. When the cable is not plugged into the computer and the dongle assembly is stored within the cavity, the input device automatically powers off.

A method for making the computer input device is also disclosed. The method comprises obtaining an outer housing comprising a top and bottom housing, forming a cavity within the bottom housing that can store a wireless receiver, assembling a sensor assembly configured to sense a position of the input device relative to a work surface, coupling a wireless transmitter to the sensor assembly, and attaching a cable comprising a cable connector configured to connect to a data port in a computer to the sensor assembly. The housing portions can be formed using any suitable process including molding. Also, in embodiments of the invention, any of the above-described components can be assembled in any suitable order to form a computer input device. The attached cable comprises data lines and power lines. Formed within the outer housing is an inner housing with a recess for holding the cable connector when the cable connector is not in use.

Embodiments of the invention may also include various systems that can incorporate any suitable combination of the above-described components. For example, some systems may include a dongle assembly in combination with an input device, an input device in combination with a host, a dongle assembly in combination with an input device and a host, etc.

Embodiments of the invention have a number of advantages. For example, as noted above, embodiments of the invention can store a cable inside of an input device such as a mouse, and can be used in a wired or wireless mode. Thus, if a user prefers using a wireless mouse, but then subsequently finds out that the mouse has run out of power, then the user can use the power and data cord provided in the input device, instead of a wireless connection. Embodiments of the invention are therefore advantageous to persons who travel.

It is noted that the present invention is not limited to the preferred embodiments described above, and it is apparent that variations and modifications by those skilled in the art can be performed within the spirit and scope of the present invention. Moreover, any one or more embodiment of the invention may be combined with one or more embodiments of the invention without departing from the spirit and scope of the invention.

Any recitation of “a”, “an” and “the” is interpreted to mean “one or more” unless specifically indicated to the contrary.

What is claimed is:

1. An input device comprising:
an outer housing;
a sensor assembly within the outer housing configured to sense a position of the input device relative to a work surface;
a wireless transmitter coupled to the sensor assembly; and
a cable comprising a cable connector, wherein the cable connector is configured to connect to a data port in a host, wherein the cable has one end coupled to the sensor assembly and another end which is capable of being coupled to the host, wherein the cable comprises data lines and power lines.

2. The input device of claim 1 further comprising an inner housing within the outer housing, wherein the inner housing comprises a recess for holding the cable connector when the cable connector is not in use.

3. The input device of claim 2 wherein the inner housing has dimensions that are smaller than the outer housing, and wherein the cable is configured to wrap around the inner housing when the cable is not in use.

4. The input device of claim 1 further comprising a dongle assembly, capable of being connected to a data port in a computer, wherein the dongle assembly comprises a wireless receiver and is capable of receiving signals from the wireless transmitter.

5. The input device of claim 4, wherein the dongle assembly is configured to connect to a PCI Express-type port of a computer.

6. The input device of claim 4 wherein the outer housing is formed from an upper housing portion and a bottom housing portion, wherein the bottom housing portion further comprises a cavity formed in the bottom housing portion, wherein the cavity is configured to store the dongle assembly when not in use.

7. The input device of claim 6 wherein the input device is a computer input device, wherein the computer input device is a computer mouse, a trackball, or a keyboard.

8. The input device of claim 1 wherein the outer housing comprises a top housing portion and a bottom housing portion, wherein the top housing portion comprises a first set of magnets and the second housing portion comprises a second set of magnets, wherein the first and second set of magnets are configured to magnetically couple to each other when the top housing portion and the bottom housing portion are assembled together to form the outer housing.

9. The input device of claim 1 wherein the outer housing comprises an aperture, and wherein the input device further comprises a scroll wheel, wherein sections of the scroll wheel are configured to controllably emit visible light.

10. The input device of claim 1 wherein the cable connector is a mini-USB cable connector or a standard pin connector.

11. The input device of claim 2 wherein the inner housing contains a battery compartment.

12. The computer input device of claim 11, wherein the mouse is powered by batteries contained within the battery compartment and the power lines of the cable.

13. The computer input device of claim 11, wherein the mouse is powered solely by batteries contained within the battery compartment when the cable connector is not in use.

14. The computer input device of claim 11, wherein the mouse is powered solely by the power lines of the cable when there are no batteries within the battery compartment or the batteries within the battery compartment are powerless.

15. A dongle assembly for an input device, the dongle assembly comprising:
a housing;
a wireless receiver coupled to the housing, the wireless receiver being configured to receive a wireless signal from a wireless transmitter in the input device; and
a first connector configured to connect the dongle assembly to a data port in a computer and a second connector configured to connect the dongle assembly to a cable coupled to the input device.

16. The dongle assembly of claim 15 wherein the data port is a PCI Express-type port.

17. The dongle assembly of claim 16 wherein the housing is shaped to fit within a PCI Express-type slot in a computer;

18. The dongle assembly of claim 15 wherein the second connector is a mini-USB cable connector or a standard pin connector.

19. A system comprising: the dongle assembly of claim 15, and the input device, wherein the cable comprises both data and power lines.

20. A dongle assembly for an input device, the dongle assembly comprising:
a housing; and
a wireless receiver coupled to the housing, the wireless receiver configured to receive a wireless signal from a wireless transmitter in the input device,
wherein the housing is shaped to fit within a PCI Express-type data port in a host.

21. The dongle assembly of claim 20, further comprising a first connector configured to connect the dongle assembly to the PCI Express-type data port and a second connector configured to connect the dongle assembly to a cable of the input device.

22. The dongle assembly of claim 20, wherein the input device is capable of communicating immediately upon connecting the dongle assembly to the host.

23. A method of using an input device, comprising:
removing a dongle assembly from within a cavity in the housing of the input device, wherein the input device automatically powers on upon the removal of the dongle assembly;
connecting the dongle assembly to a data port in a host;
inputting commands to the host using the input device, wherein the input device is in wireless communication with the dongle assembly;
connecting a cable associated with the computer input device to the host, wherein the cable comprises data lines and power lines; and
inputting commands to the host through the cable, using the input device.

24. The method of claim 23 wherein connecting the cable to the host includes plugging the cable into the dongle assembly.

25. The method of claim 23 further comprising placing the dongle assembly within the cavity in the housing of the input device, and connecting the cable to a data port in the host.

26. The method of claim 23 further comprising wrapping the cable around an inner housing of the input device when the cable is not in use.

27. A method of making an input device, comprising:
obtaining an outer housing comprising a top and bottom housing;
assembling a sensor assembly configured to sense a position of the input device relative to a work surface;
coupling a wireless transmitter to the sensor assembly; and
coupling a cable comprising a cable connector to the sensor assembly, wherein the cable is configured to connect to a data port in a host to the sensor assembly, wherein the cable comprises data lines and power lines.
